(19) United States
(12) Patent Application Publication
(10) Pub. No.: US 2009/0186545 A1
(43) Pub. Date: Jul. 23, 2009

(54) RECYCLABLE VAPOR-PERMEABLE WATERPROOF LAMINATE

(75) Inventors: Yi-Chung Hwang, Taipei (TW); Yung-Sheng Chang, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHEMOTEX MINLAN PACIFIC CO., LTD., Taipei (TW)

(21) Appl. No.: 12/016,710

(22) Filed: Jan. 18, 2008

(51) Int. Cl. B32B 27/00; D03D 15/00

(52) U.S. Cl. 442/181; 156/334

(57) ABSTRACT

The present invention provides a recyclable vapor-permeable waterproof laminate which has an outer layer and an inner layer. The outer layer is made of woven or knitted polypropylene (PP) material, and the inner layer is a polyethylene (PE) or polypropylene (PP) membrane, between which a thermal adhesive primarily made of polypropylene (PP) is provided to bond them together. The laminate of the present invention is not only able to serve as performance fabric but is also eco-friendly because the chemical structure of the materials (i.e., PP and PE) from which it is made consist of only carbon and hydrogen, and thus they will not generate toxic gas even though they are incinerated after disposal.

### FIELD OF THE INVENTION

The invention relates to a laminate which is recyclable, vapor-permeable, and waterproof.

### BACKGROUND OF THE INVENTION

Vapor-permeable waterproof laminates are often referred to as performance fabric, which generally comprises at least a layer of man-made fiber impregnated or laminated with waterproof (and/or vapor-permeable) materials like rubber, polyvinylchloride (PVC), polyurethane (PU), polytetrafluoroethylene (PTFE), etc. Various performance fabrics, ever since their invention, have offered effective protection to people who need to be exposed to harsh environments such as bad weather, high mountain regions, and deep water. The outdoor activities that people have engaged in would have been significantly limited without the help of such performance fabrics.

Nevertheless, the currently available performance fabrics possess a prominent drawback, that is, they are not recyclable. Therefore, the only way to manage disposed fabrics is to burn them. However, these fabrics generate toxic gases when they are burned, and thus will damage the environment. Accordingly, the more this sort of performance fabric is produced, the more our environment will suffer.

The monomer of the materials used to manufacture performance fabrics does not allow the latter to be eco-friendly or recyclable. Take three common performance fabrics for example:
(A) 100% nylon or 100% polyester as the outer layer, 100% polyvinylchloride (PVC) as the inner layer, and 100% polyurethane (PU) adhesive as adhesive for bonding the outer and inner layers together.
(B) 100% nylon or 100% polyester as the outer layer, 100% polyurethane (PU) as the inner layer, and 100% polyurethane (PU) adhesive as adhesive for bonding the outer and inner layers together.
(C) 100% nylon or 100% polyester as the outer layer, polytetrafluoroethylene (PTFE) as the inner layer, and 100% polyurethane (PU) adhesive as adhesive for bonding the outer and inner layers together.

Other prior art references, such as U.S. Pat. No. 4,187,390, U.S. Pat. No. 4,194,041, and U.S. Pat. No. 6,511,927, also show that the layers, laminates, or adhesives applied thereto in the construction of a vapor-permeable waterproof fabric are made of the polymers mentioned above.

Generally, the polymers used in the performance fabrics have the characteristic of a stable chemical structure, and thus cannot decompose naturally, and cannot be effectively and economically recycled by way of existing technologies. The only way to decompose them is to burn them. Among them, polyurethane (PU) is less harmful to the environment, whereas PVC and PTFE will produce toxic gases, and thus are extremely harmful to living creatures and the earth.

Therefore, there is a need to develop a performance fabric that is not only vapor-permeable and waterproof, but also eco-friendly.

### SUMMARY OF THE INVENTION

The present invention provides a laminate containing an outer layer and an inner layer bonded by an adhesive, wherein the outer layer is a woven or knitted polypropylene (PP) fabric, the inner layer is a vapor-permeable and waterproof polyethylene (PE) or polypropylene (PP) membrane, and the adhesive is a polypropylene (PP) adhesive.

Table 1 shows the constitution of the three performance fabrics as mentioned above and the present invention.

TABLE 1

| Performance Fabric | Outer layer | Inner layer | Adhesive |
|---|---|---|---|
| (A) | 100% Nylon | Polyvinyl chloride | Polyurethane (PU) |
| | or 100% Polyester | (PVC) | |
| (B) | 100% Nylon | Polyurethane (PU) | Polyurethane (PU) |
| | or 100% Polyester | | |
| (C) | 100% Nylon | Polytetrafluoroethylene | Polyurethane (PU) |
| | or 100% Polyester | (PTFE) | |
| Present invention | Polypropylene (PP) | Polyethylene (PE) or | Polypropylene (PP) |
| | | Polypropylene (PP) | |

It is known that performance fabrics generally available in the market contain polymers, such as PVC, PU, and PTFE, which are not suitable for incineration after disposal because they will generate toxic gases in the burning process. Table 2 shows some polymers commonly used in fabrics and their properties.

TABLE 2

| | | Gases | | Rubbish |
|---|---|---|---|---|
| | | generated | | Management |
| Materials | Monomer Structure | (while burned) | Recyclability | (Currently) |
| Nylon | NH(CH₂)₅COₙ | NOT toxic | recyclable | Burned, buried, or |
| | Nylon 6 | | | recycled |
| Polyester | 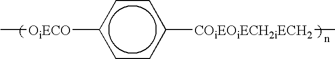 | NOT toxic | recyclable | Burned, buried, or recycled |
| Polyvinyl chloride (PVC) | 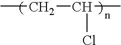 | toxic | recyclable | The vast majority buried |
| Polyurethane (PU) | 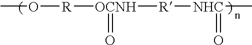 | toxic | recyclable | The vast majority buried |
| Polytetrafluoro ethylene (PTFE) | 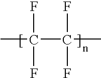 | toxic | non-recyclable | The vast majority buried |
| Polyethylene | CH₂—CH₂ₙ | NOT toxic | recyclable | Burned, buried, or |
| (PE) | | | | recycled |
| Polypropylene (PP) | 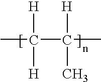 | NOT toxic | recyclable | Burned, buried, or recycled |

It is clear from Table 2 that PVC, PU, and PTFE, which are commonly used in manufacturing fabrics, are either toxic (when burned) and/or non-recyclable. In contrast, PE and PP are not toxic and recyclable, and thus are considered eco-friendly. Accordingly, the laminate of the present invention, which can be used to manufacture performance fabric, is eco-friendly and novel in the state of the art.

### BRIEF DESCRIPTION OF THE DRAWINGS

FIG. 1 shows the structure of the laminate of the present invention; and

FIG. 2 shows an arrangement of the apparatus for producing the laminate of the present invention.

### DETAILED DESCRIPTION OF THE PREFERRED EMBODIMENTS

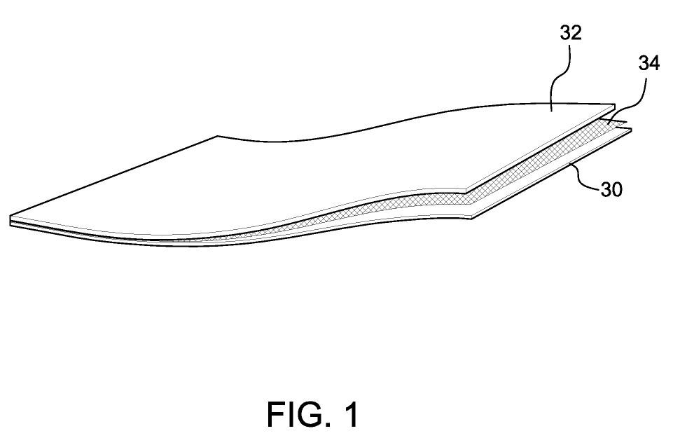

The laminate of the present invention is produced by new manufacturing technologies. It exhibits maximum comfort as already given by the best of its kind. In particular, it is 100% recyclable. As shown in FIG. 1, the laminate comprises two layers, i.e., an outer layer 30 and an inner layer 32, and an adhesive 34 that bonds the two layers. The construction of this two-layer performance fabric is as follows:

### (1) The Outer Layer

The material of the outer layer of this performance fabric is 100% polypropylene (PP), either woven or knitted. The constituent monomer of polypropylene is very simple in chemical structure and light in weight, consisting only of carbon and hydrogen atoms. This material is not only eco-friendly but also recyclable. When it is burned, it generates no toxic gases. PP is thus among the best materials, environmentally speaking. Nevertheless, PP fabric remains uncommon because technical people have been having problems with adding colors to it. Accordingly, PP material is generally not a quality commercial fabric. However, commercial production of quality PP fabric is now available from Chemotex Minlan Pacific Co., Ltd., Taiwan.

### (2) The Inner Layer

The material of the inner layer of this performance fabric is polyethylene (PE) membrane. The PE inner layer used in this invention is a vapor-permeable and waterproof 100% PE membrane, which has been on the market for a while, but has not yet received much attention due to its high price. However, it appears to be one of the best companions of the PP outer layer in a quality performance fabric. The PE adopted in the present invention is XScape™, a product distributed by Entek Membranes LLC, U.S.A. The chemical properties of PE are similar to those of PP. In the present invention, polypropylene (PP) is an alternative to PE as the material used for the inner layer of the laminate.

### (3) The Thermal Adhesive

The thermal adhesive is used to adhere the outer PP layer and the inner PE layer together. In the current textile and garment industry, there exist a wide array of thermal adhesives that are made up of different chemical monomers. The thermal adhesive adopted in the present invention is polypropylene (PP), which is available from National Adhesives, U.S.A.

In the structure of the laminate, the outer layer, inner layer, and the adhesive that bonds the outer and inner layers are either PP or PE, both of which consist only of carbon and hydrogen. Thus, the laminate of the present invention is 100% eco-friendly.

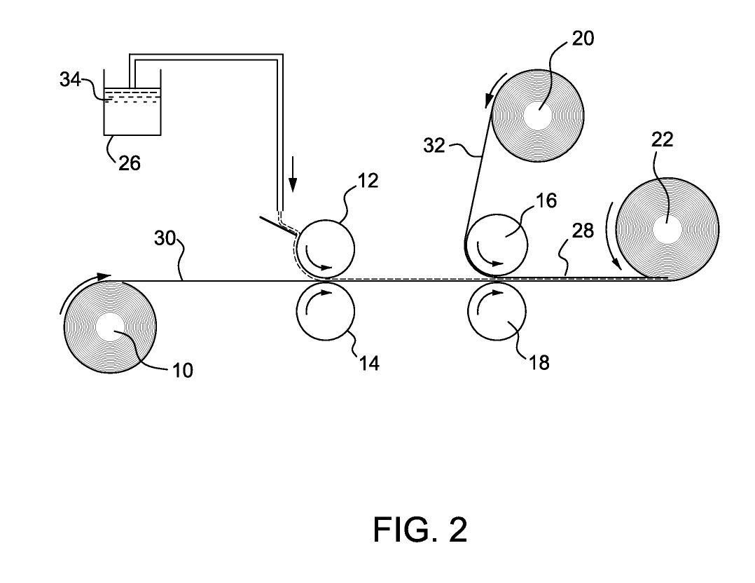

FIG. 2 schematically shows an arrangement of the apparatus for producing the laminate of the present invention. In the arrangement, the first dispensing roll 10 feeds PP fabric 30 to the nip between the upper roll 12 and lower roll 14. The adhesive 34 stored in the tank 26 is transferred to the surface of the upper roll 12. The adhesive 34 is thus applied to the surface of the PP fabric 30 after the PP fabric 30 advances through the nip between the rolls 12, 14. The PP fabric 30 with the applied adhesive 34 is then fed to the nip between the upper roll 16 and the lower roll 18. The PE fabric 32 (or another PP fabric) dispensed by the roll 20 is also fed to the same nip (between the rolls 16, 18) and is bonded with the PP fabric 30 by the adhesive 34 to form a laminate 28. The laminate 28 is subsequently collected by a take-up roll 22.

The adhesive 34 used in the present invention is preferably a non-solvent adhesive, which is, for example, polypropylene. The adhesive 34 is applied to the outer layer in a discontinuous pattern so as to achieve the vapor-permeable property. The term “discontinuous” means that the adhesive does not completely cover the surface of the outer layer. Typical discontinuous adhesive patterns include dots, cross-hatching, etc.

In addition, the preferable conditions for FIG. 2 are:
Pressure on the laminate: 3-5 Kg/m²
Line speed of roll: 10-20 m/min.
Temperature of the laminate: 100-140 degrees (Celsius)

The invention may also be implemented in other specific modes without departing from the spirit and the essence of the invention. Thus, the above-mentioned embodiments shall be regarded as explanatory but not restrictive. All changes that are consistent with the meaning and range of the claims and their equivalents shall fall within the scope claimed by the invention.

What is claimed is:

1. A recyclable, vapor-permeable, and waterproof laminate, comprising:
an outer layer made of woven or knitted polypropylene (PP) fabric;
an inner layer made of vapor-permeable and waterproof polyethylene (PE) membrane; and
a thermal adhesive made of polypropylene (PP) bonding the outer layer and the inner layer to form the laminate.

2. The laminate of claim 1, wherein the inner layer is a vapor-permeable and waterproof polypropylene (PP) membrane

3. A method of producing a recyclable, vapor-permeable, waterproof laminate, comprising the following steps:
providing an outer layer made of woven or knitted polypropylene fabric;
applying a polypropylene adhesive to the surface of the outer layer;
providing an inner layer made of vapor-permeable and waterproof polyethylene (PE) membrane;
bonding the inner layer to the outer layer;
wherein the conditions set for producing the laminate are:
pressure on the laminate: 3-5 Kg/m²
line speed of roll: 10-20 m/min.
temperature on the laminate: 100-140 degrees (Celsius)

4. The method of claim 3, wherein the inner layer is a vapor-permeable and waterproof polypropylene (PP) membrane.
